(19) United States
(12) Patent Application Publication
(10) Pub. No.: US 2025/0273886 A1
(43) Pub. Date: Aug. 28, 2025

(54) LOW HEIGHT CABLE CONNECTOR AND ASSEMBLY THEREOF

(71) Applicant: DONGGUAN LUXSHARE TECHNOLOGIES CO., LTD, Dongguan City (CN)

(72) Inventors: Kunlin YAO, Dongguan City (CN); Ruoyi ZHANG, Dongguan City (CN); Cheng LI, Dongguan City (CN)

(73) Assignee: DONGGUAN LUXSHARE TECHNOLOGIES CO., LTD, Dongguan City (CN)

(21) Appl. No.: 18/745,153

(22) Filed: Jun. 17, 2024

(30) Foreign Application Priority Data
Feb. 26, 2024 (CN) 202410211745.6

(51) Int. Cl. H01R 12/75; H01R 12/70; H01R 13/502

(52) U.S. Cl. CPC H01R 12/75; H01R 12/7047; H01R 13/502

(57) ABSTRACT

A cable connector includes a first module, a second module, a third module and a third module. The first module includes a first terminal group and a first cable. The second module includes a second terminal group and a second cable. The third module includes a third terminal group and a third cable. The fourth module includes a fourth terminal group and a fourth cable. The first terminal group and the second terminal group are arranged in a staggered manner along a second direction. The third terminal group and the fourth terminal group are arranged in a staggered manner along the second direction. The first cable and the second cable are located at a first height. The third cable and the fourth cable are located at a 10 second height. The first height is different from the second height. An assembly having the cable connector is also disclosed.

### CROSS-REFERENCE TO RELATED APPLICATION

This patent application claims priority of a Chinese Patent Application No. 202410211745.6, filed on Feb. 26, 2024 and titled “CABLE CONNECTOR AND ASSEMBLY THEREOF”, the entire content of which is incorporated herein by reference.

### TECHNICAL FIELD

The present disclosure relates to a cable connector and an assembly thereof, which belongs to the technical field of connectors.

### BACKGROUND

A cable connector in the related art usually includes a mounting body and a plurality of modules mounted to the mounting body. The plurality of modules include a first module and a second module. The first module includes a plurality of first conductive terminals and a first cable connected to the plurality of first conductive terminals. The second module includes a plurality of second conductive terminals and a second cable connected to the plurality of second conductive terminals.

As the requirements for the transmission rate of cable connectors continue to increase, the plurality of modules in the related art need to be expanded, for example, adding a third module and a fourth module. The third module includes a plurality of third conductive terminals and a third cable connected to the plurality of third conductive terminals. The fourth module includes a plurality of fourth conductive terminals and a fourth cable connected to the plurality of fourth conductive terminals. The first cable, the second cable, the third cable and the fourth cable are usually designed in a stacked manner along a height direction of the cable connector.

As the requirements for the height of the cable connector continue to increase, such stacked cables may easily cause the height of the cable connector to fail to meet the flattening requirements.

Therefore, it is desirable to improve the cable connector in the related art.

### SUMMARY

An object of the present disclosure is to provide a cable connector and an assembly thereof which can be easily reduced in height.

In order to achieve the above object, the present disclosure adopts the following technical solution: a cable connector, including: a first module, the first module including a first terminal group and a first cable; the first terminal group including a plurality of first conductive terminals arranged along a first direction; each first conductive terminal including a first contact portion configured to mate with a mating module and a first mounting portion configured to be connected to the first cable; a second module, the second module including a second terminal group and a second cable; the second terminal group including a plurality of second conductive terminals arranged along the first direction; each second conductive terminal including a second contact portion configured to mate with the mating module and a second mounting portion configured to be connected to the second cable; a third module, the third module including a third terminal group and a third cable; the third terminal group including a plurality of third conductive terminals arranged along the first direction; each third conductive terminal including a third contact portion configured to mate with the mating module and a third mounting portion configured to be connected to the third cable; and a fourth module, the fourth module including a fourth terminal group and a fourth cable; the fourth terminal group including a plurality of fourth conductive terminals arranged along the first direction; each fourth conductive terminal including a fourth contact portion configured to mate with the mating module and a fourth mounting portion configured to be connected to the fourth cable; wherein the first terminal group and the second terminal group are arranged in a staggered manner along a second direction; the third terminal group and the fourth terminal group are arranged in a staggered manner along the second direction; the first cable and the second cable are flush along a third direction and located at a first height; the third cable and the fourth cable are flush along the third direction and located at a second height; the first height is different from the second height; any two of the first direction, the second direction and the third direction are perpendicular to each other.

In order to achieve the above object, the present disclosure adopts the following technical solution: a cable connector assembly, including: a cable connector including: a first module, the first module including a first terminal group and a first cable; the first terminal group including a plurality of first conductive terminals arranged along a first direction; each first conductive terminal including a first contact portion configured to mate with a mating module and a first mounting portion configured to be connected to the first cable; a second module, the second module including a second terminal group and a second cable; the second terminal group including a plurality of second conductive terminals arranged along the first direction; each second conductive terminal including a second contact portion configured to mate with the mating module and a second mounting portion configured to be connected to the second cable; a third module, the third module including a third terminal group and a third cable; the third terminal group including a plurality of third conductive terminals arranged along the first direction; each third conductive terminal including a third contact portion configured to mate with the mating module and a third mounting portion configured to be connected to the third cable; and a fourth module, the fourth module including a fourth terminal group and a fourth cable; the fourth terminal group including a plurality of fourth conductive terminals arranged along the first direction; each fourth conductive terminal including a fourth contact portion configured to mate with the mating module and a fourth mounting portion configured to be connected to the fourth cable; wherein the first terminal group and the second terminal group are arranged in a staggered manner along a second direction; the third terminal group and the fourth terminal group are arranged in a staggered manner along the second direction; the first cable and the second cable are flush along a third direction and located at a first height; the third cable and the fourth cable are flush along the third direction and located at a second height; the first height is different from the second height; any two of the first direction, the second direction and the third direction are perpendicular to each other; a mating module; the first contact portion, the second contact portion, the third contact portion and the fourth contact portion of the cable connector are all configured to mate with the mating module; and at least one fastener fixing the cable connector and the mating module together.

Compared with the prior art, the first cable and the second cable of the present disclosure are flush along the third direction and located at a first height. The third cable and the fourth cable are flush along the third direction and located at a second height. The first height is different from the second height. With such arrangement, the first cable, the second cable, the third cable and the fourth cable are prevented from being stacked in sequence, thereby reducing the height of the cable connector and the assembly of the cable connector.

### BRIEF DESCRIPTION OF DRAWINGS

FIG. 1 is a schematic perspective view of a cable connector assembly in accordance with a first embodiment of the present disclosure;

FIG. 2 is a perspective view of FIG. 1 from another angle;

FIG. 3 is a partially exploded perspective view of FIG. 1;

FIG. 4 is a partially exploded perspective view of FIG. 3 from another angle;

FIG. 5 is a partially exploded perspective view of the cable connector of the present disclosure, in which an over-molding housing is separated;

FIG. 6 is a side view of FIG. 5;

FIG. 7 is a further exploded perspective view of FIG. 5;

FIG. 8 is a partially exploded view of a first module, a second module, a third module and a fourth module in FIG. 7, wherein the first module and the second module form one group, and the third module and the fourth module form another group;

FIG. 9 is a partial enlarged view of a circled portion B in FIG. 8;

FIG. 10 is a partial enlarged view of a circled portion C in FIG. 8;

FIG. 11 is a further exploded perspective view of FIG. 8;

FIG. 12 is a further exploded perspective view of FIG. 11;

FIG. 13 is a partial enlarged view of a frame portion D in FIG. 12;

FIG. 14 is a partial enlarged view of a frame portion E in FIG. 12;

FIG. 15 is a side view of the first module, the second module, the third module and the fourth module in FIG. 7;

FIG. 16 is a partial enlarged view of a frame portion F in FIG. 15;

FIG. 17 is a partially exploded perspective view of the cable connector of the present disclosure from another angle;

FIG. 18 is a further exploded perspective view of FIG. 17;

FIG. 19 is a perspective view of FIG. 8 from another angle;

FIG. 20 is a further exploded perspective view of FIG. 19;

FIG. 21 is a further exploded perspective view of FIG. 20; and

FIG. 22 is a top view of the cable connector assembly in accordance with a second embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

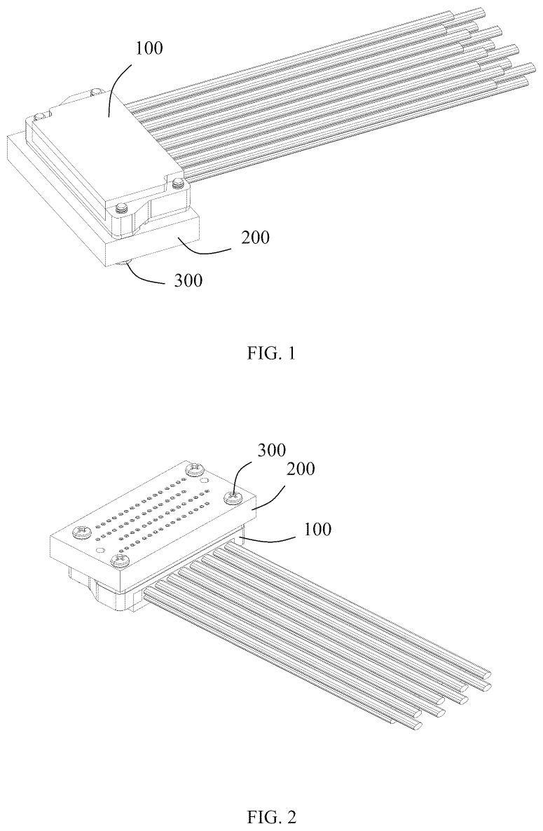

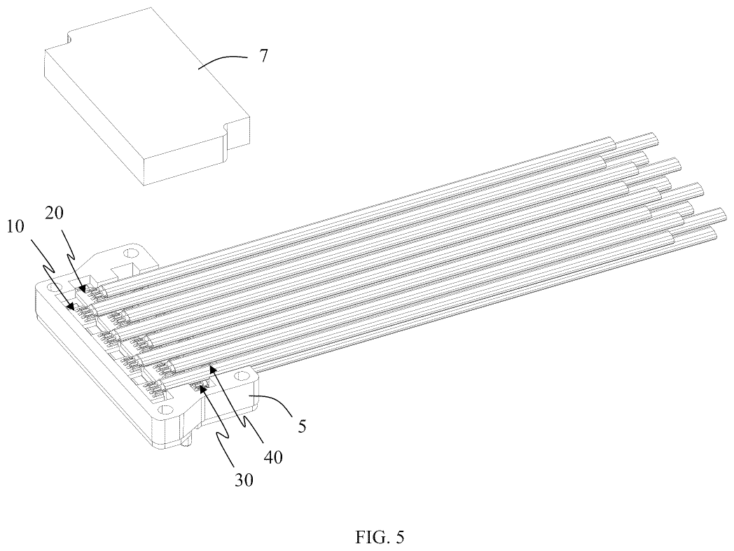

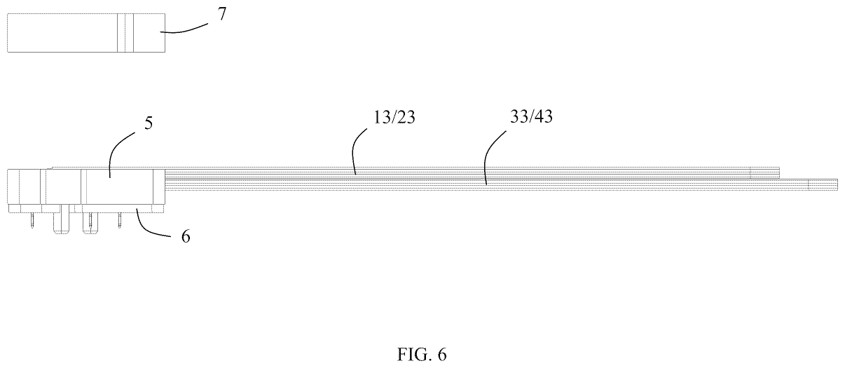

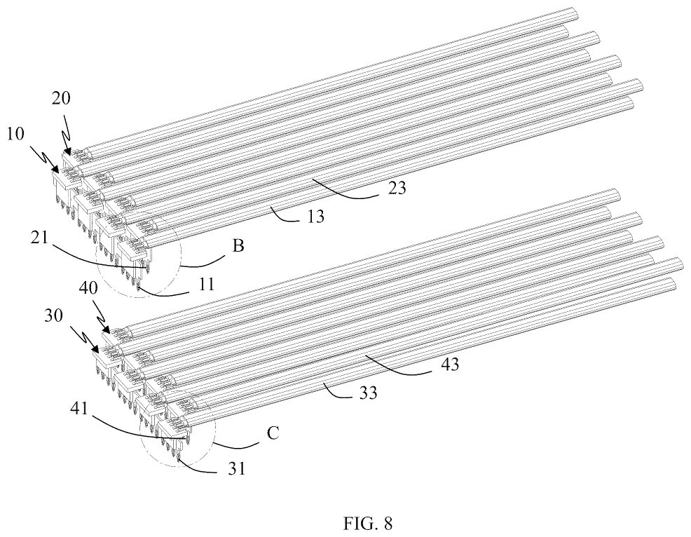

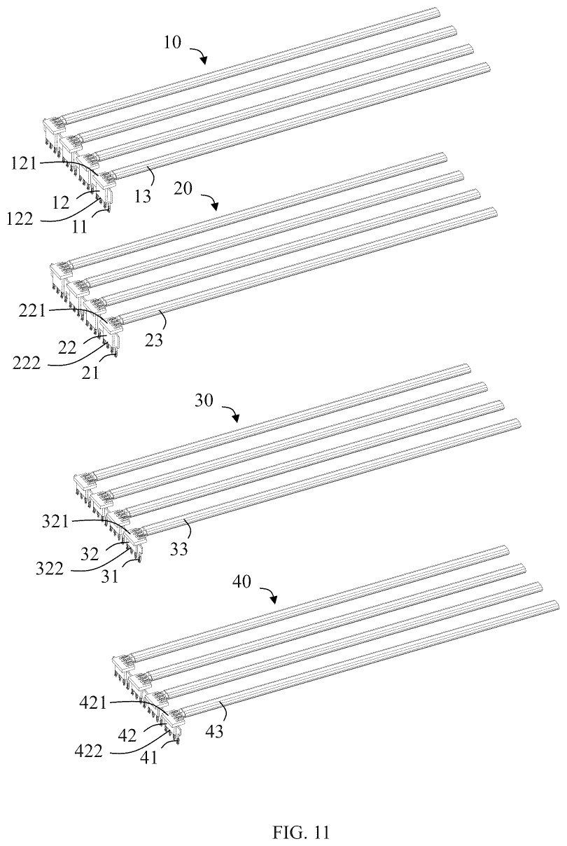

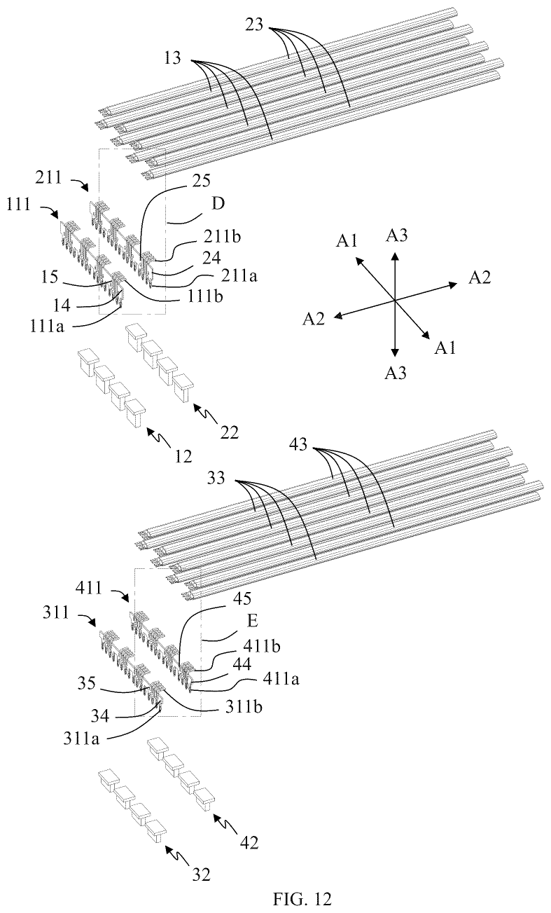

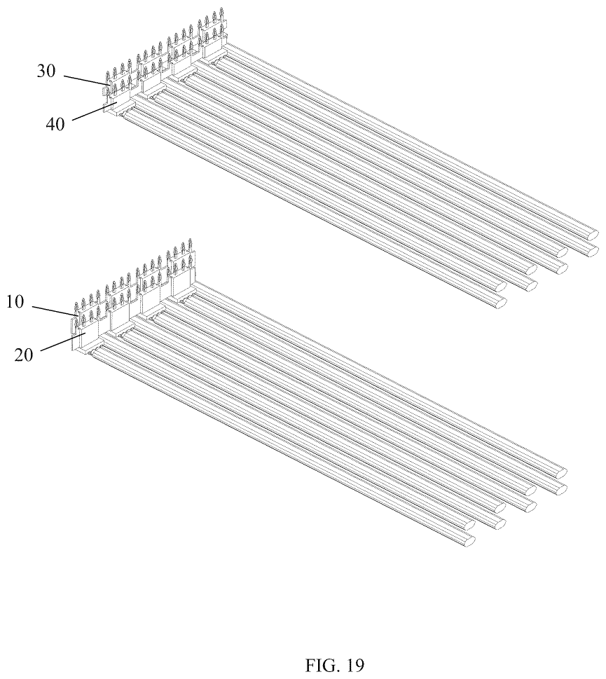

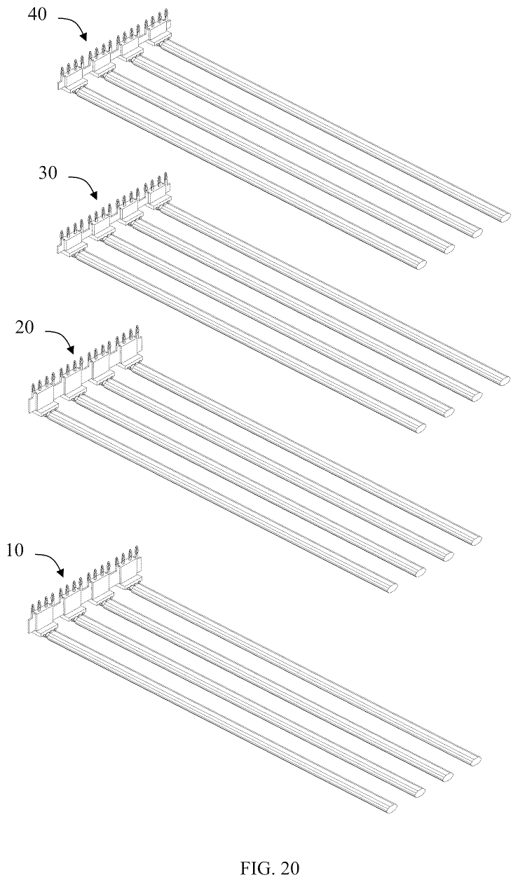

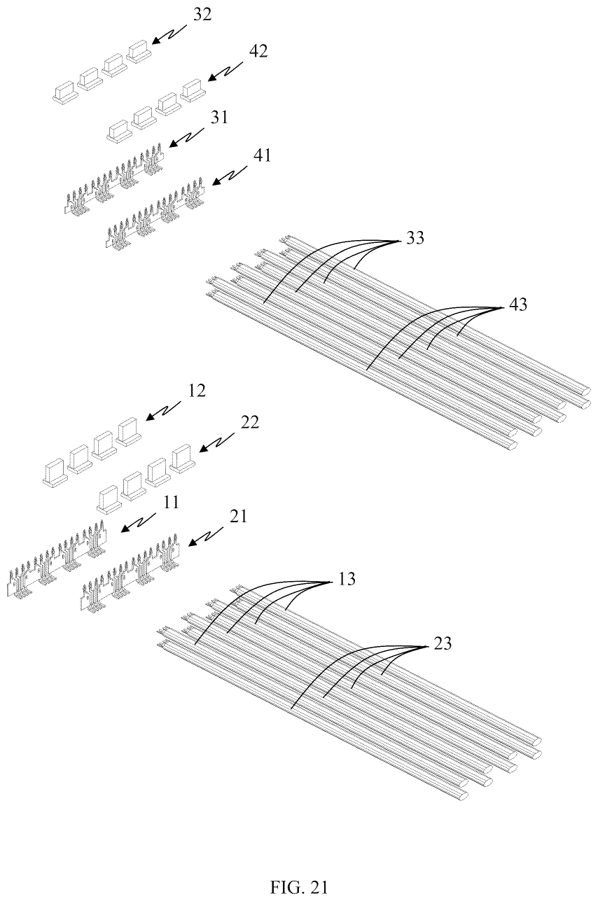

Referring to FIG. 1 to FIG. 21, the present disclosure discloses a cable connector assembly which includes a cable connector 100, a mating module 200 for mating with the cable connector 100, and at least one fastener 300 for fixing the cable connector 100 and the mating module 200 together.

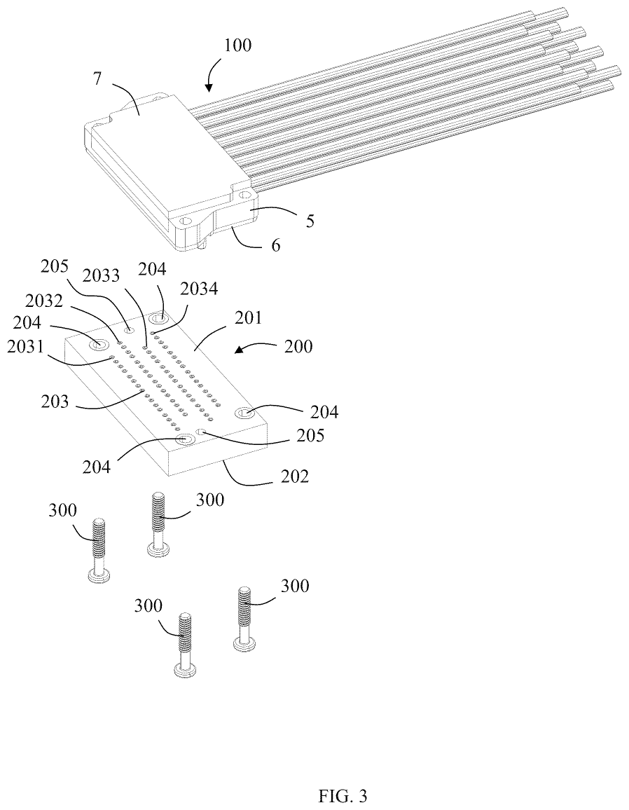

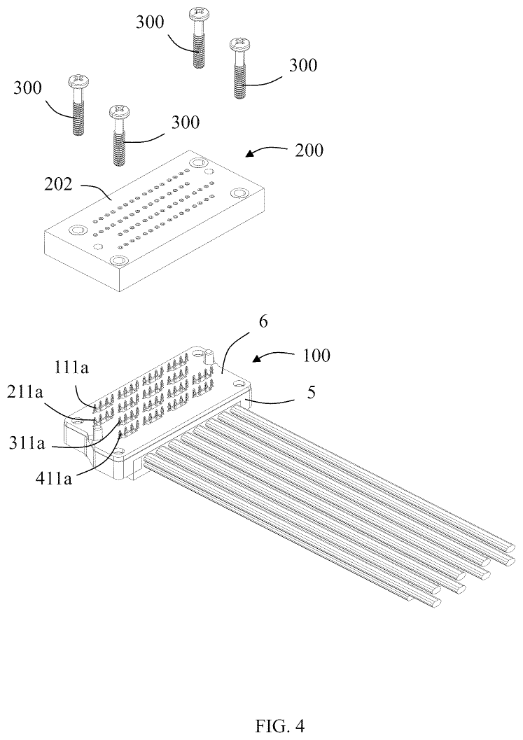

Referring to FIG. 3 and FIG. 4, in an illustrated embodiment of the present disclosure, the mating module 200 is a circuit board. The circuit board includes a first surface 201 (for example, an upper surface), a second surface 202 (for example, a lower surface) opposite to the first surface 201, and a plurality of conductive holes 203 extending through the first surface 201 and the second surface 202. It is understandable to those skilled in the art that each conductive hole 203 is a hole in which a metal conductive layer is provided on an inner wall of the hole. The plurality of conductive holes 203 can be connected through traces inside the circuit board.

Referring to FIG. 3, in the illustrated embodiment of the present disclosure, the plurality of conductive holes 203 include a plurality of first conductive holes 2031, a plurality of second conductive holes 2032, a plurality of third conductive holes 2033 and a plurality of fourth conductive holes 2034. The plurality of first conductive holes 2031 are arranged in a first row. The plurality of second conductive holes 2032 are arranged in a second row. The plurality of third conductive holes 2033 are arranged in a third row. The plurality of fourth conductive holes 2034 are arranged in a fourth row. The plurality of first conductive holes 2031, the plurality of second conductive holes 2032, the plurality of third conductive holes 2033, and the plurality of fourth conductive holes 2034 are arranged in a staggered manner. That is, the plurality of first conductive holes 2031, the plurality of second conductive holes 2032, the plurality of third conductive holes 2033, and the plurality of fourth conductive holes 2034 are not completely aligned as a whole.

Specifically, in the illustrated embodiment of the present disclosure, the number of the first conductive holes 2031, the number of the second conductive holes 2032, the number of the third conductive holes 2033 and the number of the four conductive holes 2034 are the same. The plurality of first conductive holes 2031 and the plurality of second conductive holes 2032 are arranged in a staggered manner. The plurality of third conductive holes 2033 and the plurality of fourth conductive holes 2034 are arranged in a staggered manner. The plurality of first conductive holes 2031 and the plurality of third conductive holes 2033 are arranged in alignment. The plurality of second conductive holes 2032 and the plurality of fourth conductive holes 2034 are arranged in alignment.

The circuit board further includes a plurality of first mounting holes 204 which extend through the first surface 201 and the second surface 202, and are located at four corners of the circuit board. The first mounting hole 204 allows a corresponding fastener 300 to pass through.

Besides, the circuit board further includes a plurality of positioning holes 205 extending through the first surface 201 and the second surface 202. The positioning holes 205 are configured to mate with the cable connector 100 to achieve installation positioning.

Referring to FIG. 4 to FIG. 7, in the illustrated embodiment of the present disclosure, the cable connector 100 includes a mounting body 5, a plurality of modules assembled to the mounting body 5, a conductive pad 6 in contact with a bottom of the mounting body 5, and an over-molding housing 7 over-molded on the plurality of modules and the mounting body 5.

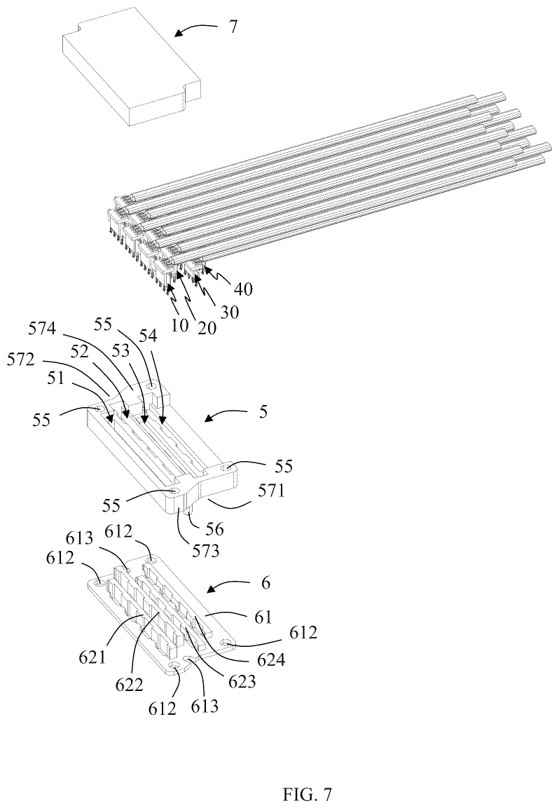

Referring to FIG. 7, in the illustrated embodiment of the present disclosure, the plurality of modules include a first module 10, a second module 20, a third module 30 and a fourth module 40.

Referring to FIG. 7 to FIG. 12, the first module 10 includes a plurality of first terminal groups 11, a first insulating block 12 fixed on each first terminal group 11, and a plurality of first cables 13. Each first terminal group 11 includes a plurality of first conductive terminals 111 arranged along a first direction A1-A1 (for example, a left-right direction). In one embodiment of the present disclosure, the plurality of first conductive terminals 111 are insert-molded with the first insulating block 12. The first insulating block 12 includes a first top surface 121 and a first bottom surface 122 opposite to the first top surface 121.

Each first conductive terminal 111 includes a first contact portion 111a configured to mate with the mating module 200 and a first mounting portion 111b configured to be connected to the first cable 13. In the illustrated embodiment of the present disclosure, the first contact portion 111a protrudes downwardly beyond the first bottom surface 122. The first mounting portion 111b is upwardly exposed to the first top surface 121.

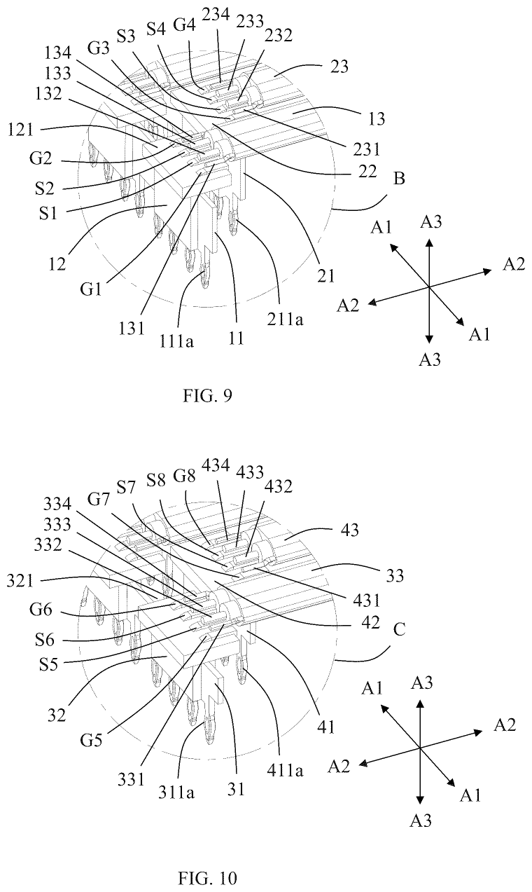

Specifically, as shown in FIG. 9, in the illustrated embodiment of the present disclosure, the first conductive terminals 111 of each first terminal group 11 include a first ground terminal G1, a first signal terminal S1, a second signal terminal S2 and a second ground terminal G2 which are disposed in sequence along the first direction A1-A1. Preferably, the first signal terminal S1 and the second signal terminal S2 form a differential pair. Each differential pair is associated with two ground terminals on both sides to increase the signal transmission rate and improve the quality of signal transmission.

Each first cable 13 includes a first ground core wire 131, a first signal core wire 132, a second signal core wire 133 and a second ground core wire 134.

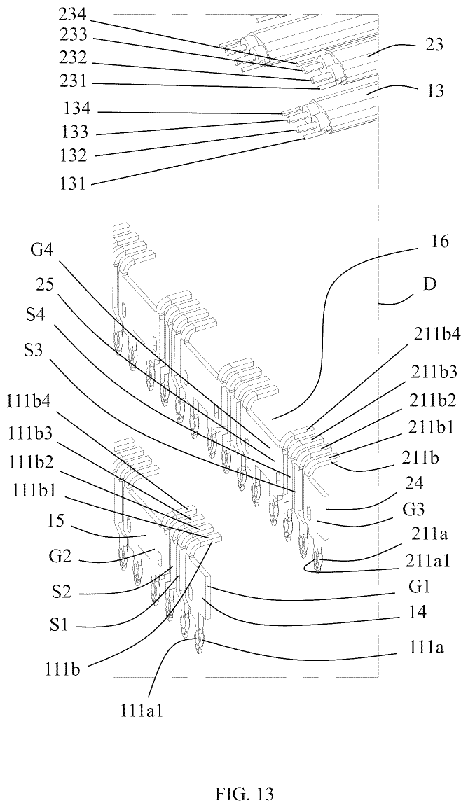

Specifically, as shown in FIG. 13, in the illustrated embodiment of the present disclosure, the first mounting portion 111b of the first ground terminal G1 includes a third grounding core wire 131 configured to be electrically connected to the first ground core wire 131. The first mounting portion 111b of the first signal terminal S1 includes a second mounting surface 111b2 configured to be electrically connected to the first signal core wire 132. The first mounting portion 111b of the second signal terminal S2 includes a third mounting surface 111b3 configured to be electrically connected to the second signal core wire 133. The first mounting portion 111b of the second ground terminal G2 includes a fourth mounting surface 111b4 configured to be electrically connected to the second ground core wire 134.

The first mounting surface 111b1 of the first ground terminal G1 and the first ground core wire 131 are fixed by soldering or welding. The second mounting surface 111b2 of the first signal terminal S1 and the first signal core wire 132 are fixed by soldering or welding. The third mounting surface 111b3 of the second signal terminal S2 and the second signal core wire 133 are fixed by soldering or welding. The fourth mounting surface 111b4 of the second ground terminal G2 and the second ground core wire 134 are fixed by soldering or welding.

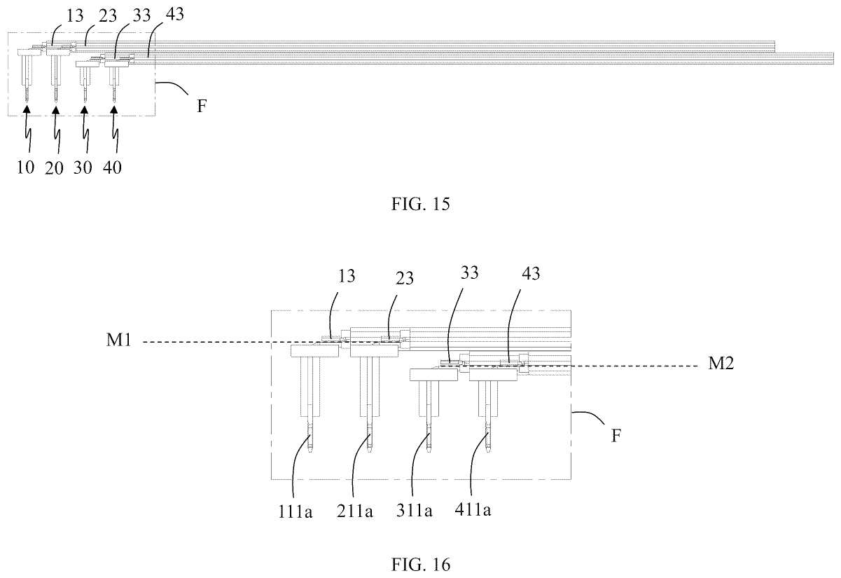

Referring to FIG. 13, FIG. 15 and FIG. 16, in the illustrated embodiment of the present disclosure, the first mounting surface 111b1, the second mounting surface 111b2, the third mounting surface 111b3 and the four mounting surface 111b4 are located at a same height and located in a first plane M1.

As shown in FIG. 7 to FIG. 12, the second module 20 includes a plurality of second terminal groups 21, a second insulating block 22 fixed on each second terminal group 21, and a plurality of second cables 23. Each second terminal group 21 includes a plurality of second conductive terminals 211 arranged along the first direction A1-A1. In one embodiment of the present disclosure, the plurality of second conductive terminals 211 are insert-molded with the second insulating block 22. The second insulating block 22 includes a second top surface 221 and a second bottom surface 222 opposite to the second top surface 221.

Each second conductive terminal 211 includes a second contact portion 211a configured to mate with the mating module 200 and a second mounting portion 211b configured to be connected to the second cable 23. In the illustrated embodiment of the present disclosure, the second contact portion 211a protrudes downwardly beyond the second bottom surface 222. The second mounting portion 211b is upwardly exposed to the second top surface 221.

Specifically, referring to FIG. 9, in the illustrated embodiment of the present disclosure, the plurality of second conductive terminals 211 of each second terminal group 21 include a third ground terminal G3, a third signal terminal S3, a fourth signal terminal S4 and a fourth ground terminal G4 which are disposed in sequence along the first direction A1-A1. Preferably, the third signal terminal S3 and the fourth signal terminal S4 form a differential pair. Each differential pair is associated with two ground terminals on both sides to increase the signal transmission rate and improve the quality of signal transmission.

Each second cable 23 includes a third ground core wire 231, a third signal core wire 232, a fourth signal core wire 233 and a fourth ground core wire 234.

Specifically, referring to FIG. 13, in the illustrated embodiment of the present disclosure, the second mounting portion 211b of the third ground terminal G3 includes a fifth mounting surface 211b1 configured to be electrically connected to the third ground core wire 231. The second mounting portion 211b of the third signal terminal S3 includes a sixth mounting surface 211b2 configured to be electrically connected to the third signal core wire 232. The second mounting portion 211b of the fourth signal terminal S4 includes a seventh mounting surface 211b3 configured to be electrically connected to the fourth signal core wire 233. The second mounting portion 211b of the fourth ground terminal G4 includes an eighth mounting surface 211b4 configured to be electrically connected to the fourth ground core wire 234.

The fifth mounting surface 211b1 of the third ground terminal G3 and the third ground core wire 231 are fixed by soldering or welding. The sixth mounting surface 211b2 of the third signal terminal S3 and the third signal core wire 232 are fixed by soldering or welding.

The seventh mounting surface 211b3 of the fourth signal terminal S4 and the fourth signal core wire 233 are fixed by soldering or welding. The eighth mounting surface 211b4 of the fourth ground terminal G4 and the fourth ground core wire 234 are fixed by soldering or welding.

Referring to FIG. 13, FIG. 15 and FIG. 16, in the illustrated embodiment of the present disclosure, the fifth mounting surface 211b1, the sixth mounting surface 211b2, the seventh mounting surface 211b3 and the eighth mounting surface 211b4 are located at a same height and located in the first plane M1. In other words, the first mounting surface 111b1 of the first ground terminal G1, the second mounting surface 111b2 of the first signal terminal S1, the third mounting surface 111b3 of the second signal terminal S2, the fourth mounting surface 111b4 of the second ground terminal G2, the fifth mounting surface 211b1 of the third ground terminal G3, the sixth mounting surface 211b2 of the third signal terminal S3, the seventh mounting surface 211b3 of the fourth signal terminal S4, and the eighth mounting surface 211b4 of the fourth ground terminal G4 are located at the same height and located in the first plane M1.

As shown in FIG. 7 to FIG. 12, the third module 30 includes a plurality of third terminal groups 31, a third insulating block 32 fixed on each third terminal group 31, and a plurality of third cables 33. Each third terminal group 31 includes a plurality of third conductive terminals 311 arranged along the first direction A1-A1. In one embodiment of the present disclosure, the plurality of third conductive terminals 311 are insert-molded with the third insulating block 32. The third insulating block 32 includes a third top surface 321 and a third bottom surface 322 opposite to the third top surface 321.

Each third conductive terminal 311 includes a third contact portion 311a configured to mate with the mating module 200 and a third mounting portion 311b configured to be connected to the third cable 33. In the illustrated embodiment of the present disclosure, the third contact portion 311a protrudes downwardly beyond the third bottom surface 322. The third mounting portion 311b is upwardly exposed to the third top surface 321.

Specifically, referring to FIG. 10, in the illustrated embodiment of the present disclosure, the plurality of third conductive terminals 311 of each third terminal group 31 include a fifth ground terminal G5, a fifth signal terminal S5, a sixth signal terminal S6 and a sixth ground terminal G6 which are disposed in sequence along the first direction A1-A1. Preferably, the fifth signal terminal S5 and the sixth signal terminal S6 form a differential pair. Each differential pair is associated with two ground terminals on both sides to increase the signal transmission rate and improve the quality of signal transmission.

Each third cable 33 includes a fifth ground core wire 331, a fifth signal core wire 332, a sixth signal core wire 333 and a sixth ground core wire 334.

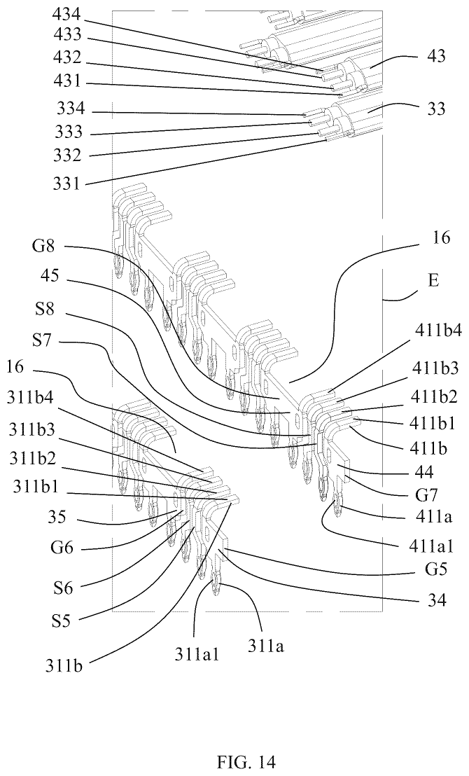

Specifically, referring to FIG. 14, in the illustrated embodiment of the present disclosure, the third mounting portion 311b of the fifth ground terminal G5 includes a ninth mounting surface 311b1 configured to be electrically connected to the fifth ground core wire 331. The third mounting portion 311b of the fifth signal terminal S5 includes a tenth mounting surface 311b2 configured to be electrically connected to the fifth signal core wire 332. The third mounting portion 311b of the sixth signal terminal S6 includes an eleventh mounting surface 311b3 configured to be electrically connected to the sixth signal core wire 333. The third mounting portion 311b of the sixth ground terminal G6 includes a twelfth mounting surface 311b4 configured to be electrically connected to the sixth ground core wire 334.

The ninth mounting surface 311b1 of the fifth ground terminal G5 and the fifth ground core wire 331 are fixed by soldering or welding. The tenth mounting surface 311b2 of the fifth signal terminal S5 and the fifth signal core wire 332 are fixed by soldering or welding. The eleventh mounting surface 311b3 of the sixth signal terminal S6 and the sixth signal core wire 333 are fixed by soldering or welding. The twelfth mounting surface 311b4 of the sixth ground terminal G6 and the sixth ground core wire 334 are fixed by soldering or welding.

Referring to FIG. 14 to FIG. 16, in the illustrated embodiment of the present disclosure, the ninth mounting surface 311b1, the tenth mounting surface 311b2, the eleventh mounting surface 311b3 and the twelfth mounting surface 311b4 are located at a same height and located in a second plane M2.

As shown in FIG. 7 to FIG. 12, the fourth module 40 includes a plurality of fourth terminal groups 41, a fourth insulating block 42 fixed on each fourth terminal group 41, and a plurality of fourth cables 43. Each fourth terminal group 41 includes a plurality of fourth conductive terminals 411 arranged along the first direction A1-A1. In one embodiment of the present disclosure, the plurality of fourth conductive terminals 411 are insert-molded with the fourth insulating block 42. The fourth insulating block 42 includes a fourth top surface 421 and a fourth bottom surface 422 opposite to the fourth top surface 421.

Each fourth conductive terminal 411 includes a fourth contact portion 411a configured to mate with the mating module 200 and a fourth mounting portion 411b configured to be connected to the fourth cable 43. In the illustrated embodiment of the present disclosure, the fourth contact portion 411a protrudes downwardly beyond the fourth bottom surface 422. The fourth mounting portion 411b is upwardly exposed to the fourth top surface 421.

Specifically, referring to FIG. 10, in the illustrated embodiment of the present disclosure, the plurality of fourth conductive terminals 411 of each fourth terminal group 41 include a seventh ground terminal G7, a seventh signal terminal S7, an eighth signal terminal S8 and an eighth ground terminal G8 which are disposed in sequence along the first direction A1-A1. Preferably, the seventh signal terminal S7 and the eighth signal terminal S8 form a differential pair. Each differential pair is associated with two ground terminals on both sides to increase the signal transmission rate and improve the quality of signal transmission.

Each fourth cable 43 includes a seventh ground core wire 431, a seventh signal core wire 432, an eighth signal core wire 433 and an eighth ground core wire 434.

Specifically, referring to FIG. 14, in the illustrated embodiment of the present disclosure, the fourth mounting portion 411b of the seventh ground terminal G7 includes a thirteenth mounting surface 411b1 configured to be electrically connected to the seventh ground core wire 431. The fourth mounting portion 411b of the seventh signal terminal S7 includes a fourteenth mounting surface 411b2 configured to be electrically connected to the seventh signal core wire 432. The fourth mounting portion 411b of the eighth signal terminal S8 includes a fifteenth mounting surface 411b3 configured to be electrically connected to the eighth signal core wire 433. The fourth mounting portion 411b of the eighth ground terminal G8 includes a sixteenth mounting surface 411b4 configured to be electrically connected to the eighth ground core wire 434.

The thirteenth mounting surface 411b1 of the seventh ground terminal G7 and the seventh ground core wire 431 are fixed by soldering or welding. The fourteenth mounting surface 411b2 of the seventh signal terminal S7 and the seventh signal core wire 432 are fixed by soldering or welding. The fifteenth mounting surface 411b3 of the eighth signal terminal S8 and the eighth signal core wire 433 are fixed by soldering or welding. The sixteenth mounting surface 411b4 of the eighth ground terminal G8 and the eighth ground core wire 434 are fixed by soldering or welding.

In the illustrated embodiment of the present disclosure, by providing the first ground core wire 131 and the second ground core wire 134 on the first cable 13, by providing the third ground core wire 231 and the fourth ground core wire 234 on the second cable 23, by providing the fifth ground core wire 331 and the sixth ground core wire 334 on the third cable 33, and by providing the seventh ground core wire 431 and the eighth ground core wire 434 on the fourth cable 43, by electrically connecting the ground core wire and the ground terminal and adopting a G-S-S-G arrangement, the cable connector 100 of the present disclosure can meet high-speed applications of 10 GHz.

Referring to FIG. 14 to FIG. 16, in the illustrated embodiment of the present disclosure, the thirteenth mounting surface 411b1, the fourteenth mounting surface 411b2, the fifteenth mounting surface 411b3 and the sixteenth mounting surface 411b4 are located at a same height and located in the second plane M2. In other words, the ninth mounting surface 311b1 of the fifth ground terminal G5, the tenth mounting surface 311b2 of the fifth signal terminal S5, the eleventh mounting surface 311b3 of the sixth signal terminal S6, the twelfth mounting surface 311b4 of the sixth ground terminal G6, the thirteenth mounting surface 411b1 of the seventh ground terminal G7, the fourteenth mounting surface 411b2 of the seventh signal terminal S7, the fifteenth mounting surface 411b3 of the eighth signal terminal S8 and the sixteenth mounting surface 411b4 of the eighth ground terminal G8 are located at the same height and located in the second plane M2.

In the illustrated embodiment of the present disclosure, the first terminal group 11 and the second terminal group 21 are arranged in a staggered manner along a second direction A2-A2 (for example, a front-rear direction). The third terminal group 31 and the fourth terminal group 41 are arranged in a staggered manner along the second direction A2-A2.

The first cables 13 and the second cables 23 are flush along a third direction A3-A3 (for example, a top-bottom direction) and located at a first height. The third cables 33 and the fourth cables 43 are flush along the third direction A3-A3 and located at a second height. The first height is different from the second height. In the illustrated embodiment of the present disclosure, the first height is higher than the second height.

In the illustrated embodiment of the present disclosure, any two directions among the first direction A1-A1, the second direction A2-A2 and the third direction A3-A3 are perpendicular to each other.

Referring to FIG. 9 and FIG. 10, in the illustrated embodiment of the present disclosure, the first contact portion 111a defines a first through hole 111a1, so that the first contact portion 111a has a certain elasticity. The second contact portion 211a defines a second through hole 211a1, so that the second contact portion 211a has a certain elasticity. The third contact portion 311a defines a third through hole 311a1, so that the third contact portion 311a has a certain elasticity. The fourth contact portion 411a defines a fourth through hole 411a1, so that the fourth contact portion 411a has a certain elasticity.

The first contact portion 111a is configured to be inserted into the first conductive hole 2031, the second contact portion 211a is configured to be inserted into the second conductive hole 2032, the third contact portion 311a is configured to be inserted into the third conductive hole 2033, and the fourth contact portion 411a is configured to be inserted into the fourth conductive hole 2034, so that the cable connector 100 and the mating module 200 are electrically connected.

Of course, it is understandable to those skilled in the art that in other embodiments of the present disclosure, the first contact portion 111a, the second contact portion 211a, the third contact portion 311a and the fourth contact portion 411a can also be designed as elastic arms. At the same time, the first conductive hole 2031, the second conductive hole 2032, the third conductive hole 2033 and the fourth conductive hole 2034 can be replaced by metal conductive pads. The cable connector 100 and the mating module 200 can also be electrically connected through the contact between the elastic arms and the metal conductive pads. Since this implementation manner is well known to those skilled in the art, it will not be described in detail in the present disclosure.

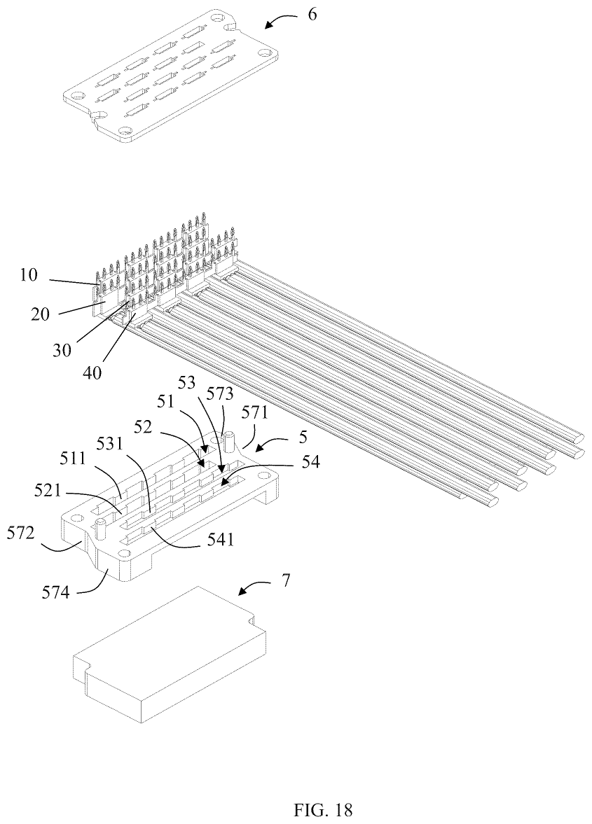

Referring to FIG. 7 and FIG. 18, in the illustrated embodiment of the present disclosure, the mounting body 5 is a metal shell. The mounting body 5 defines a first receiving groove 51, a second receiving groove 52, a third receiving groove 53 and a fourth receiving groove 54 which are disposed in sequence along the second direction A2-A2. Besides, the mounting body 5 includes a first side wall 511 exposed in the first receiving groove 51, a second side wall 521 exposed in the second receiving groove 52, a third side wall 531 exposed in the third receiving groove 53, and a fourth side wall 541 exposed in the fourth receiving groove 54. Referring to FIG. 7 and FIG. 18, in the illustrated embodiment of the present disclosure, an outline of the mounting body 5 is not a regular rectangle. The mounting body 5 includes a first notch 571 on one side and a second notch 572 on the other side. The first notch 571 and the second notch 572 are staggered along the second direction A2-A2. For example, the first notch 571 is located at a rear of one side, and the second notch 572 is located at a front of the other side. In other words, the mounting body 5 includes a first protrusion 573 on one side and a second protrusion 574 on the other side. The first protrusion 573 and the second protrusion 574 are staggered along the second direction A2-A2. In the illustrated embodiment of the present disclosure, the first notch 571 and the first protrusion 573 are located on a same side of the mounting body 5; and the first protrusion 573 is located at a front end of the first notch 571. The second notch 572 and the second protrusion 574 are located on a same side of the mounting body 5; and the second protrusion 574 is located at a rear end of the second notch 572.

It is understandable to those skilled in the art that the first terminal group 11 and the second terminal group 21 are arranged in the staggered manner along the second direction A2-A2 (for example, the front-rear direction); the third terminal group 31 and the fourth terminal group 41 are arranged in the staggered manner along the second direction A2-A2. The shape design of the mounting body 5 disclosed in the present disclosure can provide it with good structural strength and avoid failure caused by excessively thin partial wall thickness.

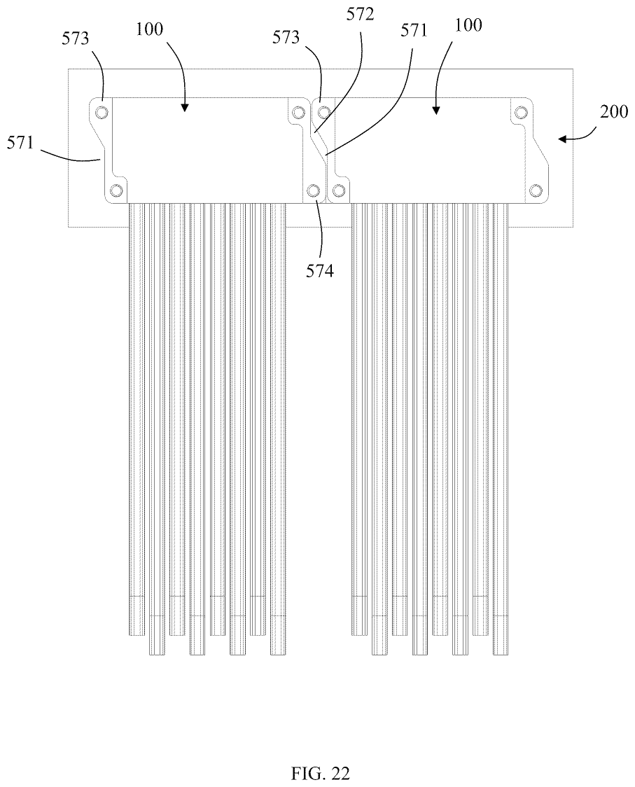

As shown in FIG. 22, in another embodiment of the present disclosure, a plurality of the cable connectors 100 can be installed to the mating module 200 in a certain arrangement. For example, the plurality of the cable connectors 100 may be installed to the mating module 200 in a matrix arrangement. Taking two adjacent cable connectors 100 as an example, the second protrusion 574 of one cable connector 100 at least partially protrudes into the first notch 571 of the other cable connector 100. At the same time, the first protrusion 573 of the other cable connector 100 at least partially protrudes into the second recess 572 of the one cable connector 100. This arrangement is relatively compact, thereby saving space occupied by the mating module 200.

Besides, the mounting body 5 further includes a plurality of second mounting holes 55 located at its four corners. The second mounting holes 55 are aligned with corresponding first mounting holes 204 respectively. The mounting body 5 further includes a plurality of positioning posts 56 protruding downwardly. The positioning posts 56 are configured to be inserted into the positioning holes 205 of the circuit board to achieve installation positioning.

In the illustrated embodiment of the present disclosure, the two second mounting holes 55 located on a same side of the mounting body 5 are also staggered along the second direction A2-A2. This arrangement can arrange the second mounting holes 55 at the four outer corners of the mounting body 5 as much as possible. With such arrangement, on the one hand, it increases the installation coverage area and improves the installation reliability; on the other hand, it can minimize the adverse impact on the internal conductive traces of the circuit board caused by opening the first mounting hole 204 on the corresponding circuit board.

The first module 10 is at least partially received in the first receiving groove 51. The second module 20 is at least partially received in the second receiving groove 52. The third module 30 is at least partially received in the third receiving groove 53. The fourth module 40 is at least partially received in the fourth receiving groove 54.

The first ground terminal G1, the second ground terminal G2, the third ground terminal G3, the fourth ground terminal G4, the fifth ground terminal G5, the sixth ground terminal G6, the seventh ground terminal G7 and the eighth ground terminal G8 are all in contact with the metal shell in order to achieve better grounding and shielding effects.

Referring to FIG. 13, in the illustrated embodiment of the present disclosure, the first ground terminal G1 includes a first vertical portion 14. The second ground terminal G2 includes a second vertical portion 15. The first vertical portion 14 and the second vertical portion 15 are both in contact with the first side wall 511.

The third ground terminal G3 includes a third vertical portion 24. The fourth ground terminal G4 includes a fourth vertical portion 25. The third vertical part 24 and the fourth vertical part 25 are both in contact with the second side wall 521.

As shown in FIG. 14, the fifth ground terminal G5 includes a fifth vertical portion 34. The sixth ground terminal G6 includes a sixth vertical portion 35. The fifth vertical portion 34 and the sixth vertical portion 35 are both in contact with the third side wall 531.

The seventh ground terminal G7 includes a seventh vertical portion 44. The eighth ground terminal G8 includes an eighth vertical portion 45. The seventh vertical portion 44 and the eighth vertical portion 45 are both in contact with the fourth side wall 541.

Along the first direction A1-A1, the plurality of the first terminal groups 11 and the plurality of the second terminal groups 21 are alternately arranged. Along the first direction A1-A1, the plurality of the first cables 13 and the plurality of the second cables 23 are alternately arranged.

Similarly, along the first direction A1-A1, the plurality of the third terminal groups 31 and the plurality of the fourth terminal groups 41 are alternately arranged. Along the first direction A1-A1, the plurality of the third cables 33 and the plurality of the fourth cables 43 are alternately arranged.

Referring to FIG. 13 and FIG. 14, in the illustrated embodiment of the present disclosure, the two first terminal groups 11 adjacent along the first direction A1-A1 share a ground terminal; the two second terminal groups 21 adjacent along the first direction A1-A1 share a ground terminal; the two third terminal groups 31 adjacent along the first direction A1-A1 share a ground terminal; the two fourth terminal groups 41 adjacent along the first direction A1-A1 share a ground terminal. The shared ground terminal of at least one of the second terminal groups 21, the third terminal groups 31 and the fourth terminal groups 41 defines an escape groove 16 for avoiding a corresponding wire.

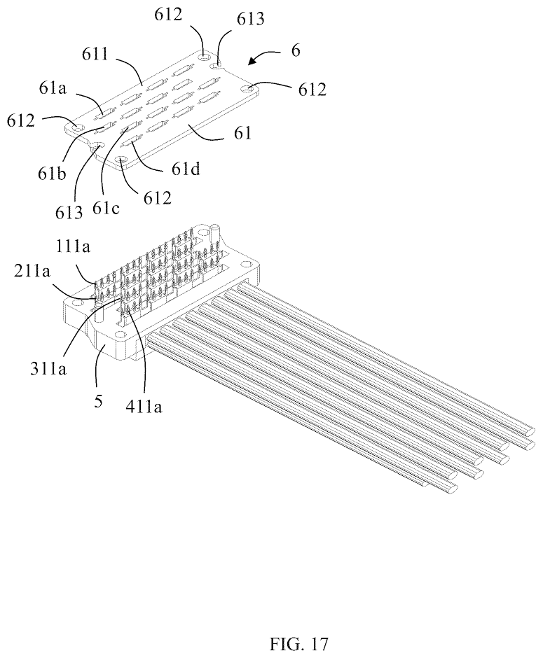

Referring to FIG. 7 and FIG. 17, in one embodiment of the present disclosure, the conductive pad 6 is made of metal material. The conductive pad 6 includes a main body 61 and a plurality of protruding blocks protruding upwardly from the main body 61. The protruding blocks include a first protruding block 621, a second protruding block 622, a third protruding block 623 and a fourth protruding block 624. The first protruding block 621 is inserted into the first receiving groove 51 from bottom to top to fix the first module 10. The second protruding block 622 is inserted into the second receiving groove 52 from bottom to top to fix the second module 20. The third protruding block 623 is inserted into the third receiving groove 53 from bottom to top to fix the third module 30. The fourth protruding block 624 is inserted into the fourth receiving groove 54 from bottom to top to fix the fourth module 40. The main body 61 is provided with a mounting surface 611 that abuts against the mating module 200. The first contact portion 111a, the second contact portion 211a, the third contact portion 311a and the fourth contact portion 411a all protrude downwardly beyond the mounting surface 611. By manufacturing the conductive pad 6 and the mounting body 5 separately, the mounting surface 611 of the conductive pad 6 can be manufactured separately without being affected by the mounting body 5, thereby reducing costs.

The main body 61 further includes a plurality of first slots 61a, a plurality of second slots 61b, a plurality of third slots 61c and a plurality of fourth slots 61d. The first slots 61a are used to allow the first contact portions 111a to pass through, so as to adjust the position of the first contact portions 111a and improve the accuracy. The second slots 61b are used to allow the second contact portions 211a to pass through, so as to adjust the position of the second contact portions 211a and improve the accuracy. The third slots 61c are used to allow the third contact portions 311a to pass through, so as to adjust the position of the third contact portions 311a and improve the accuracy. The fourth slots 61d are used to allow the fourth contact portions 411a to pass through, so as to adjust the position of the fourth contact portions 411a and improve the accuracy. Through the first slots 61a, the second slots 61b, the third slots 61c and the fourth slots 61d, the first contact portions 111a, the second contact portions 211a, the third contact portions 311a and the fourth contact portions 411a are capable of performing better position limiting, which is beneficial to improve the insertion accuracy of the first contact portions 111a, the second contact portions 211a, the third contact portions 311a and the fourth contact portions 411a into the first conductive holes 2031, the second conductive holes 2032, the third conductive holes 2033 and the fourth conductive holes 2034.

Besides, the main body 61 further includes a plurality of third mounting holes 612 located at its four corners. The third mounting holes 612 are aligned with corresponding second mounting holes 55 and corresponding first mounting holes 204 to mate with the fasteners 300. The main body 61 further includes a plurality of positioning notches 613 through which the positioning posts 56 pass.

In the illustrated embodiment of the present disclosure, the fasteners 300 are bolts, and four bolts are provided. Correspondingly, the second mounting holes 55 and the third mounting holes 612 are provided with internal threads to match external threads of the bolts.

Compared with the prior art, the first cables 13 and the second cables 23 of the present disclosure are flush along the third direction A3-A3 and located at the first height. The third cables 33 and the fourth cables 43 are flush along the third direction A3-A3 and located at the second height. The first height is different from the second height. This arrangement prevents the first cables 13, the second cables 23, the third cables 33 and the fourth cables 43 from being stacked in sequence and occupying a large height, thereby reducing the height of the cable connector 100 and the assembly of the cable connector 100.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable connector, comprising:
a first module, the first module comprising a first terminal group and a first cable; the first terminal group comprising a plurality of first conductive terminals arranged along a first direction; each first conductive terminal comprising a first contact portion configured to mate with a mating module and a first mounting portion configured to be connected to the first cable;
a second module, the second module comprising a second terminal group and a second cable; the second terminal group comprising a plurality of second conductive terminals arranged along the first direction; each second conductive terminal comprising a second contact portion configured to mate with the mating module and a second mounting portion configured to be connected to the second cable;
a third module, the third module comprising a third terminal group and a third cable; the third terminal group comprising a plurality of third conductive terminals arranged along the first direction; each third conductive terminal comprising a third contact portion configured to mate with the mating module and a third mounting portion configured to be connected to the third cable; and
a fourth module, the fourth module comprising a fourth terminal group and a fourth cable; the fourth terminal group comprising a plurality of fourth conductive terminals arranged along the first direction; each fourth conductive terminal comprising a fourth contact portion configured to mate with the mating module and a fourth mounting portion configured to be connected to the fourth cable;
wherein the first terminal group and the second terminal group are arranged in a staggered manner along a second direction; the third terminal group and the fourth terminal group are arranged in a staggered manner along the second direction;
the first cable and the second cable are flush along a third direction and located at a first height; the third cable and the fourth cable are flush along the third direction and located at a second height; the first height is different from the second height;
any two of the first direction, the second direction and the third direction are perpendicular to each other.

2. The cable connector according to claim 1, wherein the plurality of first conductive terminals comprise a first ground terminal, a first signal terminal, a second signal terminal and a second ground terminal which are disposed in sequence along the first direction;
the first cable comprises a first ground core wire, a first signal core wire, a second signal core wire and a second ground core wire;
the first mounting portion of the first ground terminal comprises a first mounting surface configured to be electrically connected to the first ground core wire; the first mounting portion of the first signal terminal comprises a second mounting surface configured to be electrically connected to the first signal core wire; the first mounting portion of the second signal terminal comprises a third mounting surface configured to be electrically connected to the second signal core wire; the first mounting portion of the second ground terminal comprises a fourth mounting surface configured to be electrically connected to the second ground core wire;
wherein the first mounting surface, the second mounting surface, the third mounting surface and the fourth mounting surface are located in the first plane.

3. The cable connector according to claim 2, wherein the plurality of second conductive terminals comprise a third ground terminal, a third signal terminal, a fourth signal terminal and a fourth ground terminal which are disposed in sequence along the first direction;
the second cable comprises a third ground core wire, a third signal core wire, a fourth signal core wire and a fourth ground core wire;
the second mounting portion of the third ground terminal comprises a fifth mounting surface configured to be electrically connected to the third ground core wire; the second mounting portion of the third signal terminal comprises a sixth mounting surface configured to be electrically connected to the third signal core wire; the second mounting portion of the fourth signal terminal comprises a seventh mounting surface configured to be electrically connected to the fourth signal core wire; the second mounting portion of the fourth ground terminal comprises an eighth mounting surface configured to be electrically connected to the fourth ground core wire;
wherein the fifth mounting surface, the sixth mounting surface, the seventh mounting surface and the eighth mounting surface are located in the first plane.

4. The cable connector according to claim 3, wherein the plurality of third conductive terminals comprise a fifth ground terminal, a fifth signal terminal, a sixth signal terminal and a sixth ground terminal which are disposed in sequence along the first direction;
the third cable comprises a fifth ground core wire, a fifth signal core wire, a sixth signal core wire, and a sixth ground core wire;
the third mounting portion of the fifth ground terminal comprises a ninth mounting surface configured to be electrically connected to the fifth ground core wire; the third mounting portion of the fifth signal terminal comprises a tenth mounting surface configured to be electrically connected to the fifth signal core wire; the third mounting portion of the sixth signal terminal comprises an eleventh mounting surface configured to be electrically connected to the sixth signal core wire; the third mounting portion of the sixth ground terminal comprises a twelfth mounting surface configured to be electrically connected to the sixth ground core wire;
wherein the ninth mounting surface, the tenth mounting surface, the eleventh mounting surface and the twelfth mounting surface are located in the second plane; the second plane and the first plane have different heights along the third direction.

5. The cable connector according to claim 4, wherein the plurality of fourth conductive terminals comprise a seventh ground terminal, a seventh signal terminal, an eighth signal terminal and an eighth ground terminal which are disposed in sequence along the first direction;
the fourth cable comprises a seventh ground core wire, a seventh signal core wire, an eighth signal core wire, and an eighth ground core wire;
the fourth mounting portion of the seventh ground terminal comprises a thirteenth mounting surface configured to be electrically connected to the seventh ground core wire; the fourth mounting portion of the seventh signal terminal comprises a fourteenth mounting surface configured to be electrically connected to the seventh signal core wire; the fourth mounting portion of the eighth signal terminal comprises a fifteenth mounting surface configured to be electrically connected to the eighth signal core wire; the fourth mounting portion of the eighth ground terminal comprises a sixteenth mounting surface configured to be electrically connected to the eighth ground core wire;
wherein the thirteenth mounting surface, the fourteenth mounting surface, the fifteenth mounting surface and the sixteenth mounting surface are located in the second plane;
the cable connector is configured to meet a high-speed application of 10 GHz.

6. The cable connector according to claim 1, wherein the first contact portion defines a first through hole; the second contact portion defines a second through hole; the third contact portion defines a third through hole; the fourth contact portion defines a fourth through hole;
the mating module is a circuit board which defines a first conductive hole, a second conductive hole, a third conductive hole and a fourth conductive hole; the first contact portion is configured to be inserted into the first conductive hole; the second contact portion is configured to be inserted into the second conductive hole; the third contact portion is configured to be inserted into the third conductive hole; the fourth contact portion is configured to be inserted into the fourth conductive hole.

7. The cable connector according to claim 1, wherein a plurality of first terminal groups and a plurality of first cables are provided;
a plurality of second terminal groups and a plurality of second cables are provided;
along the first direction, the plurality of the first terminal groups and the plurality of the second terminal groups are arranged alternately;
along the first direction, the plurality of the first cables and the plurality of the second cables are arranged alternately.

8. The cable connector according to claim 7, wherein a plurality of third terminal groups and a plurality of third cables are provided;
a plurality of fourth terminal groups and a plurality of fourth cables are provided;
along the first direction, the plurality of the third terminal groups and the plurality of the fourth terminal groups are arranged alternately;
along the first direction, the plurality of the third cables and the plurality of the fourth cables are arranged alternately.

9. The cable connector according to claim 7, wherein the first module further comprises a first insulating block fixed on each first terminal group so as to connect the first module as a whole; the second module further comprises a second insulating block fixed on each second terminal group so as to connect the second module as a whole; the third module further comprises a third insulating block fixed on each third terminal group so as to connect the third module as a whole; the fourth module further comprises a fourth insulating block fixed on each fourth terminal group so as to connect the fourth module as a whole;
the first contact portion extends beyond the first insulating block; the second contact portion extends beyond the second insulating block; the third contact portion extends beyond the third insulating block; the fourth contact portion extends beyond the fourth insulating block;
two second terminal groups adjacent along the first direction share one ground terminal; two third terminal groups adjacent along the first direction share one ground terminal; two fourth terminal groups adjacent along the first direction share one ground terminal;
at least one ground terminal of the second terminal groups, the third terminal groups and the fourth terminal groups defines an escape groove for avoiding a corresponding wire.

10. The cable connector according to claim 5, further comprising a mounting body; wherein the mounting body comprises a first receiving groove, a second receiving groove, a third receiving groove and a fourth receiving groove which are arranged in sequence along the second direction; the first module is at least partially received in the first receiving groove; the second module is at least partially received in the second receiving groove; the third module is at least partially received in the third receiving groove; the fourth module is at least partially received in the fourth receiving groove.

11. The cable connector according to claim 10, wherein the mounting body is a metal shell; the first ground terminal, the second ground terminal, the third ground terminal, the fourth ground terminal, the fifth ground terminal, the sixth ground terminal, the seventh ground terminal and the eighth ground terminal are all in contact with the metal shell.

12. The cable connector according to claim 11, wherein the first ground terminal comprises a first vertical portion; the second ground terminal comprises a second vertical portion; the mounting body comprises a first side wall exposed in the first receiving groove; the first vertical portion and the second vertical portion are both in contact with the first side wall;
the third ground terminal comprises a third vertical portion; the fourth ground terminal comprises a fourth vertical portion; the mounting body comprises a second side wall exposed in the second receiving groove; the third vertical portion and the fourth vertical portion are both in contact with the second side wall;
the fifth ground terminal comprises a fifth vertical portion; the sixth ground terminal comprises a sixth vertical portion; the mounting body comprises a third side wall exposed in the third receiving groove; the fifth vertical portion and the sixth vertical portion are both in contact with the third side wall;
the seventh ground terminal comprises a seventh vertical portion; the eighth ground terminal comprises an eighth vertical portion; the mounting body comprises a fourth side wall exposed in the fourth receiving groove; the seventh vertical portion and the eighth vertical portion are both in contact with the fourth side wall.

13. The cable connector according to claim 11, further comprising a conductive pad in contact with a bottom of the mounting body; wherein the conductive pad comprises a mounting surface which is close to the mating module; the first contact portion, the second contact portion, the third contact portion and the fourth contact portion all protrude downwardly beyond the mounting surface.

14. A cable connector assembly, comprising:
a cable connector comprising:
a first module, the first module comprising a first terminal group and a first cable; the first terminal group comprising a plurality of first conductive terminals arranged along a first direction; each first conductive terminal comprising a first contact portion configured to mate with a mating module and a first mounting portion configured to be connected to the first cable;
a second module, the second module comprising a second terminal group and a second cable; the second terminal group comprising a plurality of second conductive terminals arranged along the first direction; each second conductive terminal comprising a second contact portion configured to mate with the mating module and a second mounting portion configured to be connected to the second cable;
a third module, the third module comprising a third terminal group and a third cable;
the third terminal group comprising a plurality of third conductive terminals arranged along the first direction; each third conductive terminal comprising a third contact portion configured to mate with the mating module and a third mounting portion configured to be connected to the third cable; and
a fourth module, the fourth module comprising a fourth terminal group and a fourth cable; the fourth terminal group comprising a plurality of fourth conductive terminals arranged along the first direction; each fourth conductive terminal comprising a fourth contact portion configured to mate with the mating module and a fourth mounting portion configured to be connected to the fourth cable;
wherein the first terminal group and the second terminal group are arranged in a staggered manner along a second direction; the third terminal group and the fourth terminal group are arranged in a staggered manner along the second direction;
the first cable and the second cable are flush along a third direction and located at a first height; the third cable and the fourth cable are flush along the third direction and located at a second height; the first height is different from the second height;
any two of the first direction, the second direction and the third direction are perpendicular to each other;
a mating module; the first contact portion, the second contact portion, the third contact portion and the fourth contact portion of the cable connector are all configured to mate with the mating module; and
at least one fastener fixing the cable connector and the mating module together.

15. The cable connector assembly according to claim 14, wherein the at least one fastener is a bolt.

16. The cable connector assembly according to claim 14, wherein the plurality of first conductive terminals comprise a first ground terminal, a first signal terminal, a second signal terminal and a second ground terminal which are disposed in sequence along the first direction;
the first cable comprises a first ground core wire, a first signal core wire, a second signal core wire and a second ground core wire;
the first mounting portion of the first ground terminal comprises a first mounting surface configured to be electrically connected to the first ground core wire; the first mounting portion of the first signal terminal comprises a second mounting surface configured to be electrically connected to the first signal core wire; the first mounting portion of the second signal terminal comprises a third mounting surface configured to be electrically connected to the second signal core wire; the first mounting portion of the second ground terminal comprises a fourth mounting surface configured to be electrically connected to the second ground core wire;
wherein the first mounting surface, the second mounting surface, the third mounting surface and the fourth mounting surface are located in the first plane.

17. The cable connector assembly according to claim 16, wherein the plurality of second conductive terminals comprise a third ground terminal, a third signal terminal, a fourth signal terminal and a fourth ground terminal which are disposed in sequence along the first direction;
the second cable comprises a third ground core wire, a third signal core wire, a fourth signal core wire and a fourth ground core wire;
the second mounting portion of the third ground terminal comprises a fifth mounting surface configured to be electrically connected to the third ground core wire; the second mounting portion of the third signal terminal comprises a sixth mounting surface configured to be electrically connected to the third signal core wire; the second mounting portion of the fourth signal terminal comprises a seventh mounting surface configured to be electrically connected to the fourth signal core wire; the second mounting portion of the fourth ground terminal comprises an eighth mounting surface configured to be electrically connected to the fourth ground core wire;
wherein the fifth mounting surface, the sixth mounting surface, the seventh mounting surface and the eighth mounting surface are located in the first plane.

18. The cable connector assembly according to claim 17, wherein the plurality of third conductive terminals comprise a fifth ground terminal, a fifth signal terminal, a sixth signal terminal and a sixth ground terminal which are disposed in sequence along the first direction;
the third cable comprises a fifth ground core wire, a fifth signal core wire, a sixth signal core wire, and a sixth ground core wire;
the third mounting portion of the fifth ground terminal comprises a ninth mounting surface configured to be electrically connected to the fifth ground core wire; the third mounting portion of the fifth signal terminal comprises a tenth mounting surface configured to be electrically connected to the fifth signal core wire; the third mounting portion of the sixth signal terminal comprises an eleventh mounting surface configured to be electrically connected to the sixth signal core wire; the third mounting portion of the sixth ground terminal comprises a twelfth mounting surface configured to be electrically connected to the sixth ground core wire;
wherein the ninth mounting surface, the tenth mounting surface, the eleventh mounting surface and the twelfth mounting surface are located in the second plane; the second plane and the first plane have different heights along the third direction.

19. The cable connector assembly according to claim 18, wherein the plurality of fourth conductive terminals comprise a seventh ground terminal, a seventh signal terminal, an eighth signal terminal and an eighth ground terminal which are disposed in sequence along the first direction;
the fourth cable comprises a seventh ground core wire, a seventh signal core wire, an eighth signal core wire, and an eighth ground core wire;
the fourth mounting portion of the seventh ground terminal comprises a thirteenth mounting surface configured to be electrically connected to the seventh ground core wire; the fourth mounting portion of the seventh signal terminal comprises a fourteenth mounting surface configured to be electrically connected to the seventh signal core wire; the fourth mounting portion of the eighth signal terminal comprises a fifteenth mounting surface configured to be electrically connected to the eighth signal core wire; the fourth mounting portion of the eighth ground terminal comprises a sixteenth mounting surface configured to be electrically connected to the eighth ground core wire;
wherein the thirteenth mounting surface, the fourteenth mounting surface, the fifteenth mounting surface and the sixteenth mounting surface are located in the second plane;
the cable connector is configured to meet a high-speed application of 10 GHz.

20. The cable connector assembly according to claim 19, wherein the cable connector further comprises a mounting body; wherein the mounting body comprises a first receiving groove, a second receiving groove, a third receiving groove and a fourth receiving groove which are arranged in sequence along the second direction; the first module is at least partially received in the first receiving groove; the second module is at least partially received in the second receiving groove; the third module is at least partially received in the third receiving groove; the fourth module is at least partially received in the fourth receiving groove;
wherein the mounting body is a metal shell; the first ground terminal, the second ground terminal, the third ground terminal, the fourth ground terminal, the fifth ground terminal, the sixth ground terminal, the seventh ground terminal and the eighth ground terminal are all in contact with the metal shell.
